(19) United States
(12) Patent Application Publication
(10) Pub. No.: US 2009/0249694 A1
(43) Pub. Date: Oct. 8, 2009

(54) REMOVABLE STORM WINDOW SYSTEM

(76) Inventor: Carl Michael Nilsson, Cleveland Hts., OH (US)

Correspondence Address: HAHN LOESER & PARKS, LLP, One GOJO Plaza, Suite 300, AKRON, OH, 44311-1076, US

(21) Appl. No.: 12/062,508

(22) Filed: Apr. 3, 2008

(51) Int. Cl. E06B 3/30

(52) U.S. Cl. 49/62; 52/745.13

(57) ABSTRACT

A removable storm window system for insulating a permanent window that is fixed in a wall opening circumscribed by a casing with walls that project frontward from the permanent window. The window system includes a system frame with structural members that form a peripheral frame and a subframe attached therein. The subframe includes at least one structural member that extends between members of the peripheral frame, thereby creating a plurality of window openings in the system frame. A system attachment device is on the peripheral frame, for removably attaching the system within the casing. Sashes are dimensioned to sealingly fit in the window openings, each sash having a sash frame that holds a window pane, and a sash portion of a sash attachment on the sash frame. A frame portion of the sash attachment is on the system frame. Thus the removable storm window system provides a removably installable storm window that has a plurality of individually removable and/or operable framed sash windows.

### TECHNICAL FIELD OF THE INVENTION

The present invention relates to a removable system for insulating a window and, more particularly, said system having a plurality of operable sashes.

### BACKGROUND OF THE INVENTION

It is well known to mount “storm windows” over permanent windows of a building in order to provide better insulation against heat transfer through the permanent window, and usually also to block drafts, i.e., air passing through gaps in and around the permanent window's framing. Storm windows are particularly needed on older buildings having single pane glazing and/or air leaks caused by aging (e.g., deteriorated caulking, loose sashes, building settling that warps the shape of the wall opening).

Some storm windows are removable but not operable, and thus must be removed or re-installed with each seasonal change. If the storm window is installed on the outside of the permanent windows, then difficulty and expense are added to nuisance for installation/removal on any window above the ground level story. Operable storm windows are generally fixed in place—i.e., permanently installed, for example double or triple track vertically sliding aluminum storm window systems. These are not very attractive and so are typically installed on the outside of the permanent windows. However, it may be desired to keep the outside appearance up as well.

One solution is to install replacement windows, but this is expensive and may also change the architectural “look” of the building. This is particularly a problem with historical buildings. Thus there is a need for storm windows that do not change the appearance of the windows. Particularly if mounted inside of a historical building, the storm window must be installable and removable without marring the window casing around the wall opening. Furthermore, it is desirable to have the flexibility to operate the storm window(s) so that the permanent window can be operated to allow ventilating air to pass through both.

### BRIEF SUMMARY OF THE INVENTION

A removable storm window system is disclosed. It has many possible advantageous uses, but is particularly suited for installation inside a historical building window. It is a removably mounted storm window system (ISW) for use with window(s) that are surrounded by a window casing having walls that project inward.

In an exemplary embodiment, the ISW has a four-sided peripheral frame built to loosely fit within the casing, and one or more, preferably a plurality, of sashes (modular windows, or sash windows) that are removably mounted within the frame, using a subframe of vertical and horizontal structural members as needed (for strength) or as desired (aesthetically).

The sash modules are independently operable and/or removable from the subframe.

The subframe structure is customizable in terms of dimensions and placement of the structural members. This is useful not only for structural reasons, but also to allow matching the structure of the existing window. The latter produces an unchanged outward appearance of a building, e.g., one that seeks to maintain historical architectural status.

The frame has compression fittings that adjustably project laterally outward from the periphery of the frame for jam-fitting the frame within the casing, thereby installing without modification or damage to the casing.

Preferably a conformable sealing strip surrounds the frame and projects laterally outward such that it compresses and deforms during frame installation, thereby conforming to a potentially irregularly shaped casing for sealing the gap between frame and it against drafts (convective heat exchange). Preferably the sealing strip is a durable gasket that also provides insulation to reduce conductive heat exchange.

The ISW is suitable for removable temporary use, or it can be left in place as a permanent installation.

The compression fitting method combined with the system frame that holds modular sash windows is an important feature.

Another important feature is a removable system frame that in turn houses a plurality of modular sashes that are individually operable and/or removable.

Other objects, features and advantages of the invention will become apparent in light of the following description thereof.

### BRIEF DESCRIPTION OF THE DRAWINGS

Reference will be made herein to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements in selected ones of the drawings may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

Elements of the figures can be numbered such that similar (including identical) elements may be referred to with similar numbers in a single drawing. For example, each of a plurality of elements collectively referred to as 199 may be referred to individually as 199a, 199b, 199c, etc. Or, related but modified elements may have the same number but are distinguished by primes. For example, 109, 109′, and 109″ are three different elements which are similar or related in some way, but have significant modifications. Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying drawings, wherein:

FIG. 1 is a

FIG. 2 is . . . , according to the invention. etc.

### DETAILED DESCRIPTION OF THE INVENTION

The present invention will now be described with reference to an illustrated embodiment wherein the inventive system is removably installed inside (in front of) a permanent window in a wall opening through an exterior wall. It will be seen that the invention is not limited to such an application; it can also be removably installed on the other side of the permanent window, be it in an exterior wall or an interior wall. Therefore, what is shown and described as an interior mounted storm window system, should be understood to represent equivalent mounting on the other side. To avoid confusion, the term “front” will generally be used herein instead of “inside” or “inward” (directed interior-ward of a building wall). Similarly, the term “back” will generally be used instead of “outside” or “outward” (directed toward the exterior of a building). In general for the present disclosure, “front” (inside) will refer to the side of a permanent window where the inventive window system is installed.

Also, the term “storm window” is used herein in a general sense of being effective for insulating a permanent window. The “insulation” may be for heat/cold, i.e., thermal transfer as from outdoor weather, but could also be used to muffle sound transfer. Thus the inventive “storm window” can be used to improve sound and/or thermal insulation for a permanent window mounted in any wall opening, even between two rooms, for example rooms at different temperatures like a walk-in cooler.

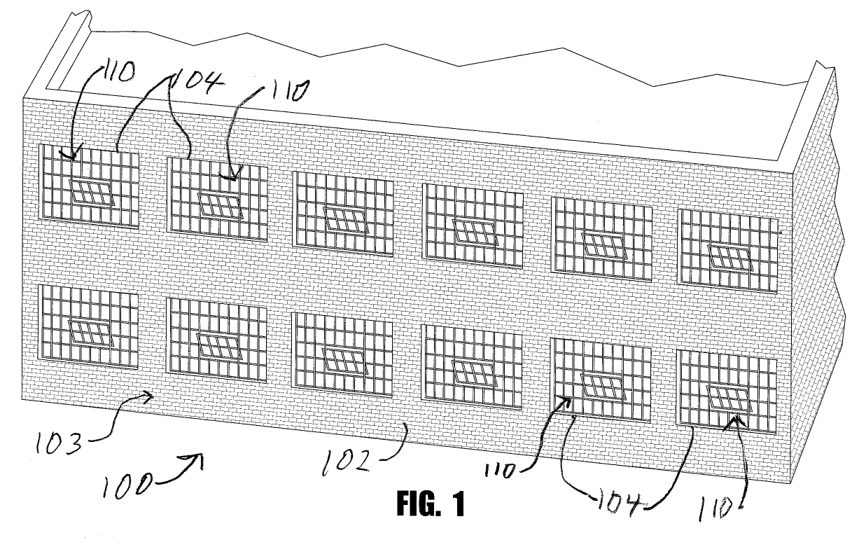

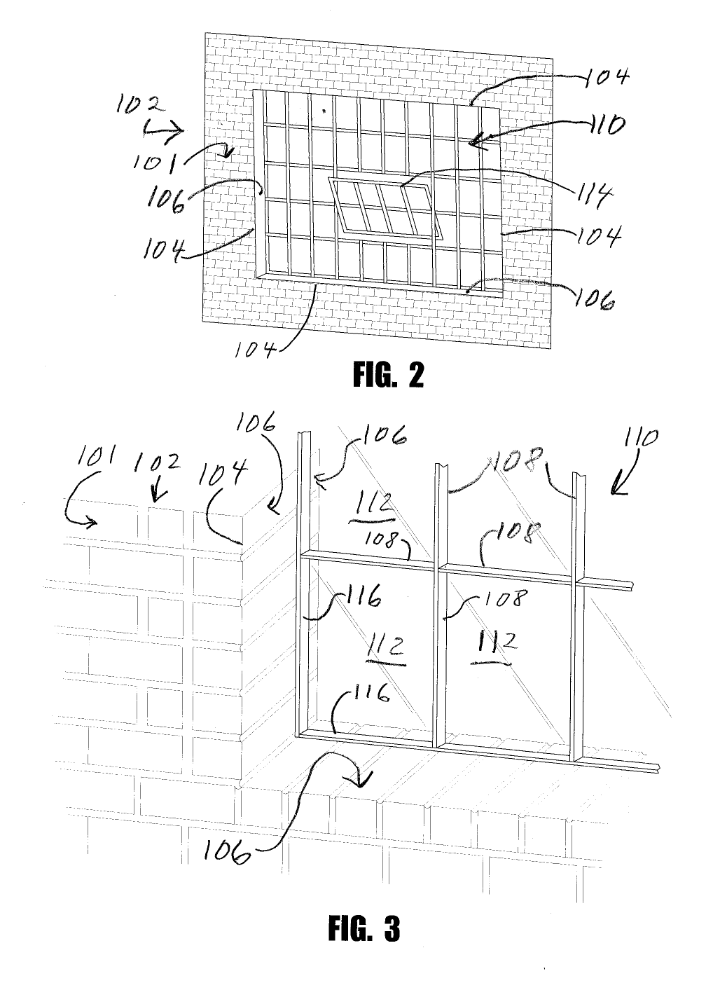

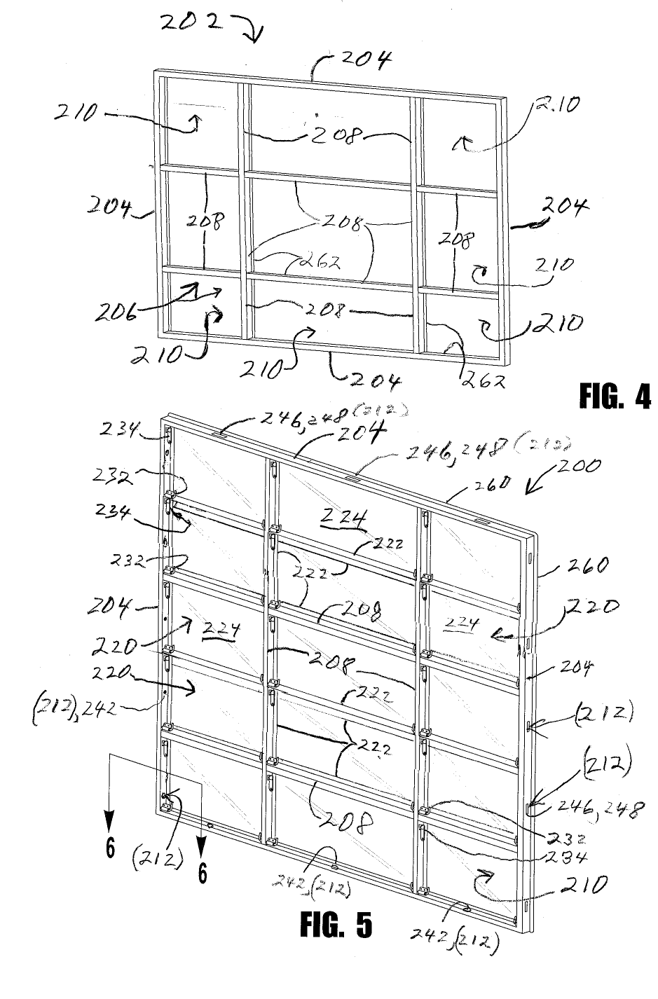

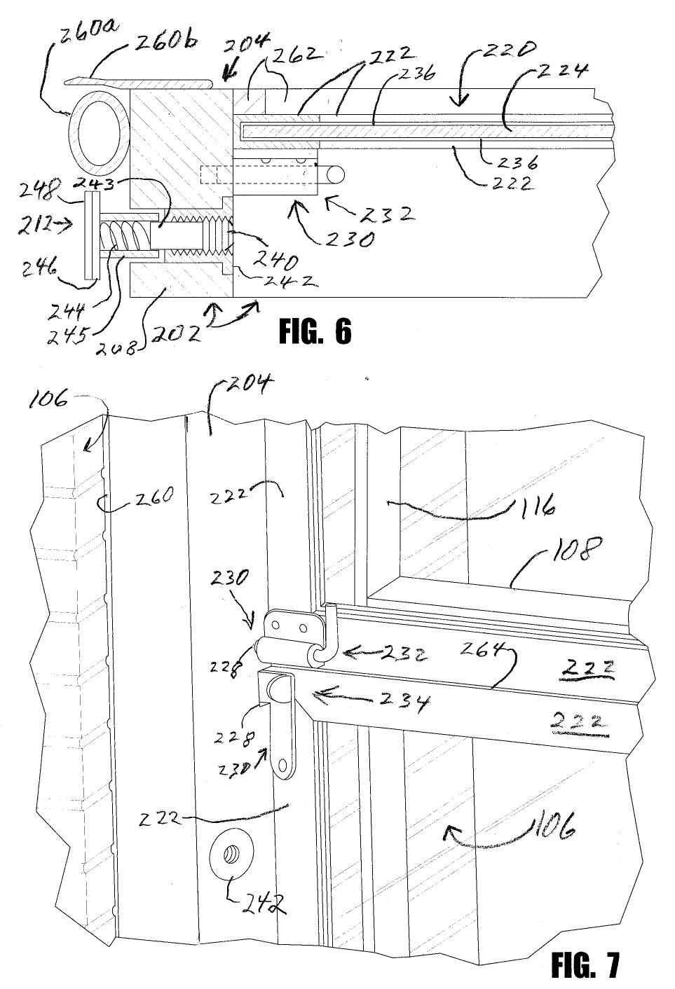

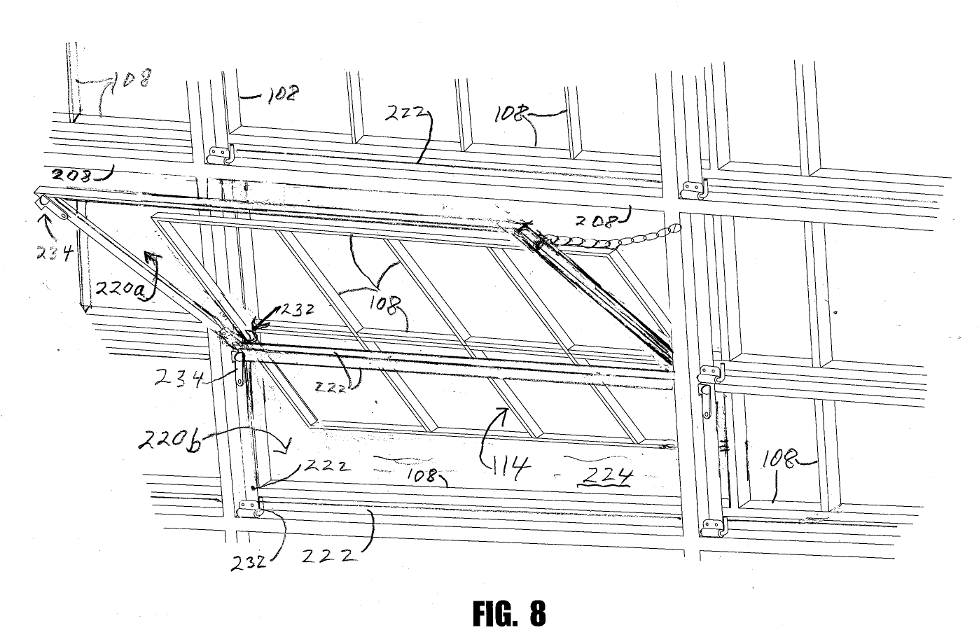

FIG. 1 illustrates a building 100 in need of the inventive removable storm window system (or simply “system”). The building 100 is an example of an old commercial building with walls 102 made of brick and having a plurality of large wall openings 104, each of which has a permanent window 110 installed within it. Historically, such a high percentage of the exterior wall 102 being open was required for admitting sunlight into an otherwise poorly lighted interior (before inexpensive large area electric lighting was commonly available). Referring also to FIGS. 2-3, the permanent windows 110 are large, so they are subdivided by horizontal and vertical muntins 108 that form of grid of rectangles into which window panes 112 are permanently glazed. For ventilation, a portion of the permanent window 110 is formed into a center-pivoting tilt window 114. A surrounding frame 116 forms a peripheral structure for the entire permanent window 110. The muntins 108 and the frame 116 are, for example, made of steel slats welded together (e.g., 1 inch by 3/16 inch bar stock).

The wall opening 104 extends through the wall 102 from a front (e.g., interior) surface 101 to a back (e.g., outdoor) surface 103. The sides of the wall opening 104 are a window casing 106 that comprises a sill across the bottom of the wall opening 104, a lintel above, and a vertical jamb on each side. In this example, the casing 106 extends all the way from the front surface 101 to the back surface 103, however it will be seen that the inventive window system 200 can be (removably) installed in any casing 106 that extends frontward from the permanent window 110 on at least two opposed sides of the casing 106 (two jambs, or sill and lintel). The permanent window's surrounding frame 116 is permanently affixed to the casing 106, however since it is brick, the casing 106 has rough, uneven, and often crooked or slanting walls such that the surrounding frame 116 must be heavily caulked to the casing 106 in order to seal the inevitable gaps between the two.

Obviously this permanent window 110 needs insulation. And if it is a designated historical building 100, then a storm window is preferable to a replacement or modification of the permanent window 110 so that the historical permanent windows 110 will look the same as before insulating them, at least from one side (e.g., the outside). Thus the storm window must not change the appearance of the permanent window 110. For example, any muntins or framing of the storm window must be aligned with corresponding muntins 108 and frame 116 of the permanent window 110. Furthermore, the storm window should be removable in case the inside appearance of the permanent window 110 becomes important. Preferably, the casing 106 should not be marred by the storm window being installed or removed. Also preferably, at least portions of the storm window should be either removable or operable such that an opening can be created in the storm window to allow operation of the permanent window 110 (e.g., opening the tilt window 114). Since there are often many such windows to be insulated, as in the exemplary building 100, the storm window should be relatively simple and quick to install and remove properly (e.g., without marring). Ideally the storm window will maintain a good draft-proof seal in the wall opening 104 regardless of thermal conditions such as ambient temperature changes that may be very dramatic under the influence of seasonal changes, day-night changes, intermittent use of heating inside the building, and the like. Finally, the storm window should be installable in a way that establishes a good seal even in a wall opening 104 that is crooked. In other words, in addition to possibly being rough and uneven, the casing 106 may have bowed or tilted walls such that a rectangular (square-cornered) storm window can be installed and sealed in a non-rectangular casing 106. (The terms “rectangle” and “rectangular” are used herein to refer to square-cornered, i.e., about ninety degrees, four-sided shapes regardless of whether or not the four sides are of equal length. Thus the term “rectangle” includes the meaning of the term “square”.)

The inventive removable storm window system 200 (“system”) was developed to meet all of these requirements, as will now be disclosed.

FIG. 4 illustrates a system frame 202 constructed from sturdy structural members 208 being, for example, one inch wide by two inches deep rectangular wooden bars. This is just one example of material and dimension—obviously extruded aluminum or plastic, hollow tubing or solid, are other examples. The system frame 202 has a peripheral frame 204 of surrounding structural members 208, such that the peripheral frame 204 has a shape that substantially conforms to the overall shape of the casing 106, and as much as possible also matches the overall shape of the permanent window 110 (e.g., a rectangle even if the casing 106 has shifted over time from a rectangle to a bit of a parallelogram). Here it is four-sided, but the shape could be circular for an oriel window, fan shaped for a transom window, etc. Within the peripheral frame 204 is a subframe 206, also made from sturdy structural members 208. Thus the subframe 206 in the peripheral frame 204 creates a plurality of window openings 210.

It is important to understand that the system frame 202 is mainly intended to provide structural strength to the window system 200, rather than to provide a frame of muntins that are permanently glazed. Thus the subframe 206 provides structural members 208 that extend between sides of the peripheral frame 204 to serve as equivalents of load bearing mullions (but not limited to vertical use). The system frame 202 is made this way for a variety of reasons, including especially the strength and rigidity for the window system 200, which must be transported, installed and/or removed without damage or distortion; and which must resist bending of the peripheral frame 204 while the installed system 200 is held in place by compressive system attachment devices 212 that press laterally outward from the peripheral frame 204 against the casing wall 106.

Another advantage imbued by the structural subframe 206 is that the peripheral frame 204 can be made using less substantial (e.g., thinner) structural elements 208 than would otherwise be needed to provide the desired strength and rigidity for the window system 200 if the peripheral frame 204 were the only portion of the window system 200 providing that strength and rigidity. This allows for more flexibility in designing the window system 200 so that it most closely matches the appearance of the permanent window 110. For example, the size and shape of each structural member 208 of the system frame 202 can be individually determined first of all by the desire to match the appearance of the permanent window 110, and then the quantity and placement (and perhaps choice of materials) of the structural members 208 can be determined such that the desired strength and rigidity of the system frame 202 are obtained.

FIG. 5 shows a fully constructed and assembled removable storm window system 200. Between the structural members 208 of the peripheral frame 204 and the attached subframe 206, in the window openings 210, are installed a plurality of sash windows (sashes) 220 that are individually removable and operable. The sashes 220 are a sash frame 222 holding a window pane 224 and a sash portion 226 of a sash attachment 230 mounted on the sash frame 222. A corresponding frame portion 228 of the sash attachment 230 is formed in the structural members of the system frame. The sash attachments 230, are, for example, a pivot pin 232 passing through a sliding mount into a hole in the frame, and a swinging latch 234 that swings into a slot in the frame. This allows the sash 220 to be removably installed, as well as operated by swinging open a latch 234 and pivoting the sash 220 on the pivot pin 232. No doubt many other forms of sash attachments 230 can be applied for this use, and all are considered within the scope of the present invention providing they are equivalent to the function of the sash attachments 230 in terms of allowing a sash window 220 to be removably installed in the system frame 202, and/or to be operable for opening and closing a portion of a window opening in the system frame 202.

FIG. 6 shows in partial cross section (where indicated by the line 6-6 in FIG. 5) a sash 220 that is permanently glazed with a window pane 224 (e.g., glass) and a resilient gasket 236 between an aluminum U-channel used for the sash frame 222 and the pane 224. A flange 262 (e.g., a rabbet) may be provided on the system frame 202 to make a stop against which the sash window 220 can be mounted and operably closed—optionally with a sash gasket 264 sealing the interface. A resilient, conformable frame gasket 260 is provided to seal the gap between the system frame 202 and the casing 106 as seen in FIG. 7. Note that the example installation illustrated in FIG. 7 shows a situation wherein the frame gasket 260 conforms to the rough brick surface plus the indented mortar, and also fills a V-shaped gap caused by a slanted casing wall 106. Many types of such gaskets 260 are known and may be used with the present invention as long as they meet requirements, if any, such as preventing drafts and/or conductive thermal transfer; such as providing a uniform appearance without unsightly gaps, and such as not marring the walls of the casing 106. For example, silicone caulk could be used as a sealing gasket 260 if unmarred removability isn't required. For example, the “gasket” 260 could be implemented as a decorative molding that covers the gap and is attached to the peripheral frame 204. Two preferred examples of suitable frame gaskets are resilient tubing 260a (hollow or solid) and a resilient leaf or ribbon 260b. The leaf gasket 260b could be advantageously used to seal the peripheral frame 204 if it is pressed back against the permanent window's frame 116.

The system frame 202 is held in the casing 106 by compressive system attachment devices 212 that press laterally outward from the peripheral frame 204 against the casing wall 106. A preferred embodiment of the system attachment device 212 is shown in partial cross section in FIG. 6. A screw threaded stud 240 travels in a correspondingly threaded screw hole 242. A convenient implementation of the screw hole 242 is shown as a threaded sleeve that is glued, riveted, or otherwise secured in the structural member 208 of the peripheral frame 204. The stud 240 has a rod portion 243 that extends laterally outward from the peripheral frame 204. This could be used by itself to apply pressure on the casing wall 106, but would no doubt mar the casing 106 when the stud 240 is screw-advanced laterally outward to press against it. To achieve a non-marring form of the compressive system attachment device 212, a protective pad 246 (e.g., a swivel pad) is provided at the end of the stud 240 to protect the casing wall 106. Preferably a cushioning pad 248 is on the end of the stud 240 (e.g., felt). More preferably the cushioning pad 248 is resilient such that it resists slipping as well as providing cushioning. If the cushioning pad 248 is made of a sufficiently resilient material it will add a spring bias to the compression of the screw stud 240, thereby allowing for expansion and contraction of the system frame 202 and/or the casing 106 when they are subjected to changes in thermal conditions (air temperature, radiant heating, etc.). A most preferred embodiment of the system attachment device 212 utilizes a bias spring 244 that has more range of compression/extension than a rubber pad. For example, FIG. 6 shows a coiled compression spring 244 contained in a sleeve 245 that holds it between and in line with the screw stud 240 and the pad(s) 246 and/or 248. The screw's rod portion 243 may advantageously be non-threaded for easier sliding in the spring sleeve 245. It will be seen in the forgoing description that there may be an advantage to leaving the compression springs 244 out of the bottom frame attachment devices 212 (if they are supporting too much weight), and possibly also the attachment devices 212 on one of the two side portions of the peripheral frame 204.

As best seen in FIG. 5, the system attachment devices 212 are spaced apart along all sides of the peripheral frame 204, some being recognized by the rectangular pad(s) 246, 248 and some by the circular threaded screw hole 242, as dictated by the angle of perspective view. The illustrated positioning of the system attachment devices 212 is merely representative. The actual quantity and positioning of the devices 212 will be decided by the designer of the system frame 202 according to engineering principles applied to existent factors such as characteristics of the casing walls 106, dimensions of the system frame 202, bending and compressive strength of the structural members 208, relative positioning of the subframe's structural members 208, and the like. These considerations provide evidence of benefit from the inventive use of a subframe structure 206 made of sturdy structural members 208 that extend between opposing portions of the peripheral frame 204. It should now be clear that the subframe members 208 are “load-bearing” like architectural mullions but not only for vertical weight loading from above, but rather in all directions due to the presence of compressive system attachment devices 212 which apply a reactive force laterally inward as they press laterally outward against any of the casing walls 106.

Installation of the inventive window system 200 is simplified by the use of the compressive system attachment devices 212, especially when they include a spring bias of some kind. Although the compressive force can be provided by a variety of attachment device 212 constructions, a preferred implementation is one that includes some type of screw adjustment (e.g., the screw threaded stud 240 in the threaded screw hole 242) for controlled lateral extension of a compressing element (e.g., stud 240, protective pad 246, and/or cushioning pad 248) toward and against the casing 106. Using the preferred screw adjustment (or a similar means of controlling the level of compressive force), the installation method for the removable storm window system 200 becomes a relatively simple matter of:
a. Holding a pre-constructed system frame 202 in position within the casing 106 while advancing the bottom system attachment devices 212 until the system frame 202 is positioned as desired both vertically and tilt-wise,
b. Advancing the system attachment devices 212 on one of the sides until the system frame 202 is positioned as desired horizontally, and
c. Advancing the top and other side system attachment devices 212 until a suitable and uniform amount of compressive force is developed for all of the frame attachment devices 212.

A screw 240 of a screw-adjustable compressive attachment device 212 can be turned by a power driver, and the “suitable” amount of compressive force can be determined initially by a knowledgeable person and then can be uniformly repeated, even by unskilled labor, using a torque limiter on the power driver. If a compressive biasing spring (e.g., spring 244) is used in the system attachment device 212, then there is a bit more latitude on the “suitable” amount of force (torque), and this makes installation even easier, along with the other advantages it brings (e.g., temperature change compensation).

This simple installation method allows the system frame 202 to be “squared up” in the casing 106, regardless of its shape.

It can be seen from the above described installation method that installation (or removal) is made much easier by not having the significant weight of window panes to deal with, not to mention the added risk of breakage taken on when installing a large window. Also, the removable storm window system 200 is much easier to transport when separated into packages of manageable weight.

FIGS. 4, 5, 7 and 8 illustrate some aspects of the versatility offered by the inventive removable storm window system 200.

The system frame 202 does not have to conform to the exact layout of the permanent window's muntins 108. Less structural members 208 can be employed, and then the rest of the framing lines can be provided by the sash window frames 222. In the illustrated example, the permanent window 110 has muntins 108 laid out in a five-row by ten-column pattern, whereas the window system 200 uses a system frame 202 laid out with only two vertical and two horizontal structural members 208 in the subframe 206 (see FIG. 4). Also, the subframe members 208 are spaced apart both vertically and horizontally to accommodate the height and width of the tilt window 114. Now using sash windows 220 of only two standardized sizes established by the bottom row of window openings 210, the five row appearance is maintained (see FIG. 5) because two of the sash windows 220 will fit in each of the two-row window openings 210, and the light blockage of the double row of adjacent top and bottom sash frame members 222 (shown close up in FIG. 7) looks similar to the light blockage of the rows divided by a structural member 208. Of course that effect can be improved upon by narrowing the width of the structural members 208, and/or by changing their height. For example, the horizontal members 208 could be reduced in height ⅜″ so that the sash windows 220 could be installed over them with top and bottom sash frames 222 abutting the same as they do in the double height window openings. This would not require any change to the sash attachments 230 as long as at least a portion of the vertical structural members 208 is left at the original height.

Where two sash frames 222 are abutted a sash gasket 264 can be affixed to one of the sash frame edges in order to seal the interface. Of course other means can be used, such as establishing an interference fit by shaping the abutting frame edges (e.g., edges that are slanted at slightly different angles).

FIG. 8 shows a portion of the removable storm window system 200 that is removably installed in front of the exemplary permanent window 110. A single one of the sash windows 220 (labeled sash 220a) has been unlatched (232) and pivoted open on its pivoting sash attachments 232 to allow access to the tilting portion 114 of the permanent window 110. This enabled opening the tilting window 114 into the space allowed by the opened sash 220a. The bottom one of the two sashes 220 in the window opening (labeled sash 220b) did not have to be opened, but could be in order to allow more ventilation. If the seasons have changed and the tilt window 114 will be opened frequently, then one or both of the center sash windows 220a, 220b can be easily removed for the sake of convenience. Removal is simply a matter of unlatching the latch 234 type of sash attachment 230 and sliding out the pivot pin 232 of the pivoting type of sash attachment 230.

Other advantages of the inventive window system 200 include the following.

Since they are not permanently glazed or otherwise installed into the system frame 202, the sash windows 220 can be made in a broad variety of forms and still be used in the same system frame 202. Thus sash windows 220, being glazing in a frame, can be for example single, double, or triple glazed, with a variety of glass types or any other type of “window pane” (including opaque panels and window screening). Differently glazed sashes 220 can be installed in different window openings 210, and can be moved around or changed as desired.

The window system 200 is prepared off-site and assembled very quickly on-site without the requirement of placing anchors into the walls. The installation does not require the occupants to leave the premises.

The subframe 206 is designed in such a way that it will transmit the compressive forces of the system attachment devices 212 without any buck playing off the peripheral frame 204.

The gaskets surrounding the system frame 202 and the individual sash windows 220 create an excellent seal against air leakage through any part of the wall opening covered by the inventive removable storm window system 200.

Although the invention has been illustrated and described in detail in the drawings and foregoing description, the same is to be considered as illustrative and not restrictive in character—it being understood that only preferred embodiments have been shown and described, and that all changes and modifications that come within the spirit of the invention as claimed are desired to be protected. Undoubtedly, many other “variations” on the “themes” set forth hereinabove will occur to one having ordinary skill in the art to which the present invention most nearly pertains, and such variations are intended to be within the scope of the invention, as disclosed herein.

### TECHNICAL FIELD OF THE INVENTION

The present invention relates to a removable system for insulating a window and, more particularly, said system having a plurality of operable sashes.

### BACKGROUND OF THE INVENTION

It is well known to mount “storm windows” over permanent windows of a building in order to provide better insulation against heat transfer through the permanent window, and usually also to block drafts, i.e., air passing through gaps in and around the permanent window's framing. Storm windows are particularly needed on older buildings having single pane glazing and/or air leaks caused by aging (e.g., deteriorated caulking, loose sashes, building settling that warps the shape of the wall opening).

Some storm windows are removable but not operable, and thus must be removed or re-installed with each seasonal change. If the storm window is installed on the outside of the permanent windows, then difficulty and expense are added to nuisance for installation/removal on any window above the ground level story. Operable storm windows are generally fixed in place—i.e., permanently installed, for example double or triple track vertically sliding aluminum storm window systems. These are not very attractive and so are typically installed on the outside of the permanent windows. However, it may be desired to keep the outside appearance up as well.

One solution is to install replacement windows, but this is expensive and may also change the architectural “look” of the building. This is particularly a problem with historical buildings. Thus there is a need for storm windows that do not change the appearance of the windows. Particularly if mounted inside of a historical building, the storm window must be installable and removable without marring the window casing around the wall opening. Furthermore, it is desirable to have the flexibility to operate the storm window(s) so that the permanent window can be operated to allow ventilating air to pass through both.

### BRIEF SUMMARY OF THE INVENTION

A removable storm window system is disclosed. It has many possible advantageous uses, but is particularly suited for installation inside a historical building window. It is a removably mounted storm window system (ISW) for use with window(s) that are surrounded by a window casing having walls that project inward.

In an exemplary embodiment, the ISW has a four-sided peripheral frame built to loosely fit within the casing, and one or more, preferably a plurality, of sashes (modular windows, or sash windows) that are removably mounted within the frame, using a subframe of vertical and horizontal structural members as needed (for strength) or as desired (aesthetically).

The sash modules are independently operable and/or removable from the subframe.

The subframe structure is customizable in terms of dimensions and placement of the structural members. This is useful not only for structural reasons, but also to allow matching the structure of the existing window. The latter produces an unchanged outward appearance of a building, e.g., one that seeks to maintain historical architectural status.

The frame has compression fittings that adjustably project laterally outward from the periphery of the frame for jam-fitting the frame within the casing, thereby installing without modification or damage to the casing.

Preferably a conformable sealing strip surrounds the frame and projects laterally outward such that it compresses and deforms during frame installation, thereby conforming to a potentially irregularly shaped casing for sealing the gap between frame and it against drafts (convective heat exchange). Preferably the sealing strip is a durable gasket that also provides insulation to reduce conductive heat exchange.

The ISW is suitable for removable temporary use, or it can be left in place as a permanent installation.

The compression fitting method combined with the system frame that holds modular sash windows is an important feature.

Another important feature is a removable system frame that in turn houses a plurality of modular sashes that are individually operable and/or removable.

Other objects, features and advantages of the invention will become apparent in light of the following description thereof.

### BRIEF DESCRIPTION OF THE DRAWINGS

Reference will be made herein to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements in selected ones of the drawings may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

Elements of the figures can be numbered such that similar (including identical) elements may be referred to with similar numbers in a single drawing. For example, each of a plurality of elements collectively referred to as 199 may be referred to individually as 199a, 199b, 199c, etc. Or, related but modified elements may have the same number but are distinguished by primes. For example, 109, 109′, and 109″ are three different elements which are similar or related in some way, but have significant modifications. Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying drawings, wherein:

FIG. 1 is a perspective view of an exemplary commercial building having a plurality of large wall openings, each of which has a permanent window installed within it.

FIG. 2 is a perspective view of a one of the permanent windows of FIG. 1 showing parts of the permanent window, and the wall and casing in which it is installed.

FIG. 3 is a magnified perspective view of a lower left portion of the permanent window installation of FIG. 2.

FIG. 4 is a perspective view of a system frame according to the invention.

FIG. 5 is a perspective view of a fully constructed and assembled removable storm window system, wherein a plurality of individually removable and operable sash windows are installed in window openings of the system frame of FIG. 4, all according to the invention.

FIG. 6 is a sectional view, taken in the direction indicated by the line and arrows 6-6 in FIG. 5, showing portions of a glazed sash window in a system frame, sash attachments, gasket seals, and a compressive system attachment device, all according to the invention.

FIG. 7 is a perspective view of portions of the inventive window system installed in the casing inside of the permanent window of FIG. 3, all according to the invention.

FIG. 8 is a perspective view of a center portion of the window system and permanent window of FIG. 7, showing one of the sash windows being operably tilted open to accommodate an opened tilt window of the permanent window, all according to the invention.

### DETAILED DESCRIPTION OF THE INVENTION

The present invention will now be described with reference to an illustrated embodiment wherein the inventive system is removably installed inside (in front of) a permanent window in a wall opening through an exterior wall. It will be seen that the invention is not limited to such an application; it can also be removably installed on the other side of the permanent window, be it in an exterior wall or an interior wall. Therefore, what is shown and described as an interior mounted storm window system, should be understood to represent equivalent mounting on the other side. To avoid confusion, the term “front” will generally be used herein instead of “inside” or “inward” (directed interior-ward of a building wall). Similarly, the term “back” will generally be used instead of “outside” or “outward” (directed toward the exterior of a building). In general for the present disclosure, “front” (inside) will refer to the side of a permanent window where the inventive window system is installed.

Also, the term “storm window” is used herein in a general sense of being effective for insulating a permanent window. The “insulation” may be for heat/cold, i.e., thermal transfer as from outdoor weather, but could also be used to muffle sound transfer. Thus the inventive “storm window” can be used to improve sound and/or thermal insulation for a permanent window mounted in any wall opening, even between two rooms, for example rooms at different temperatures like a walk-in cooler.

FIG. 1 illustrates a building 100 in need of the inventive removable storm window system (or simply “system”). The building 100 is an example of an old commercial building with walls 102 made of brick and having a plurality of large wall openings 104, each of which has a permanent window 110 installed within it. Historically, such a high percentage of the exterior wall 102 being open was required for admitting sunlight into an otherwise poorly lighted interior (before inexpensive large area electric lighting was commonly available). Referring also to FIGS. 2-3, the permanent windows 110 are large, so they are subdivided by horizontal and vertical muntins 108 that form of grid of rectangles into which window panes 112 are permanently glazed. For ventilation, a portion of the permanent window 110 is formed into a center-pivoting tilt window 114. A surrounding frame 116 forms a peripheral structure for the entire permanent window 110. The muntins 108 and the frame 116 are, for example, made of steel slats welded together (e.g., 1 inch by 3/16 inch bar stock).

The wall opening 104 extends through the wall 102 from a front (e.g., interior) surface 101 to a back (e.g., outdoor) surface 103. The sides of the wall opening 104 are a window casing 106 that comprises a sill across the bottom of the wall opening 104, a lintel above, and a vertical jamb on each side. In this example, the casing 106 extends all the way from the front surface 101 to the back surface 103, however it will be seen that the inventive window system 200 can be (removably) installed in any casing 106 that extends frontward from the permanent window 110 on at least two opposed sides of the casing 106 (two jambs, or sill and lintel). The permanent window's surrounding frame 116 is permanently affixed to the casing 106, however since it is brick, the casing 106 has rough, uneven, and often crooked or slanting walls such that the surrounding frame 116 must be heavily caulked to the casing 106 in order to seal the inevitable gaps between the two.

Obviously this permanent window 110 needs insulation. And if it is a designated historical building 100, then a storm window is preferable to a replacement or modification of the permanent window 110 so that the historical permanent windows 110 will look the same as before insulating them, at least from one side (e.g., the outside). Thus the storm window must not change the appearance of the permanent window 110. For example, any muntins or framing of the storm window must be aligned with corresponding muntins 108 and frame 116 of the permanent window 110. Furthermore, the storm window should be removable in case the inside appearance of the permanent window 110 becomes important. Preferably, the casing 106 should not be marred by the storm window being installed or removed. Also preferably, at least portions of the storm window should be either removable or operable such that an opening can be created in the storm window to allow operation of the permanent window 110 (e.g., opening the tilt window 114). Since there are often many such windows to be insulated, as in the exemplary building 100, the storm window should be relatively simple and quick to install and remove properly (e.g., without marring). Ideally the storm window will maintain a good draft-proof seal in the wall opening 104 regardless of thermal conditions such as ambient temperature changes that may be very dramatic under the influence of seasonal changes, day-night changes, intermittent use of heating inside the building, and the like. Finally, the storm window should be installable in a way that establishes a good seal even in a wall opening 104 that is crooked. In other words, in addition to possibly being rough and uneven, the casing 106 may have bowed or tilted walls such that a rectangular (square-cornered) storm window can be installed and sealed in a non-rectangular casing 106. (The terms “rectangle” and “rectangular” are used herein to refer to square-cornered, i.e., about ninety degrees, four-sided shapes regardless of whether or not the four sides are of equal length. Thus the term “rectangle” includes the meaning of the term “square”.)

The inventive removable storm window system 200 (“system”) was developed to meet all of these requirements, as will now be disclosed.

FIG. 4 illustrates a system frame 202 constructed from sturdy structural members 208 being, for example, one inch wide by two inches deep rectangular wooden bars. This is just one example of material and dimension—obviously extruded aluminum or plastic, hollow tubing or solid, are other examples. The system frame 202 has a peripheral frame 204 of surrounding structural members 208, such that the peripheral frame 204 has a shape that substantially conforms to the overall shape of the casing 106, and as much as possible also matches the overall shape of the permanent window 110 (e.g., a rectangle even if the casing 106 has shifted over time from a rectangle to a bit of a parallelogram). Here it is four-sided, but the shape could be circular for an oriel window, fan shaped for a transom window, etc. Within the peripheral frame 204 is a subframe 206, also made from sturdy structural members 208. Thus the subframe 206 in the peripheral frame 204 creates a plurality of window openings 210.

It is important to understand that the system frame 202 is mainly intended to provide structural strength to the window system 200, rather than to provide a frame of muntins that are permanently glazed. Thus the subframe 206 provides structural members 208 that extend between sides of the peripheral frame 204 to serve as equivalents of load bearing mullions (but not limited to vertical use). The system frame 202 is made this way for a variety of reasons, including especially the strength and rigidity for the window system 200, which must be transported, installed and/or removed without damage or distortion; and which must resist bending of the peripheral frame 204 while the installed system 200 is held in place by compressive system attachment devices 212 that press laterally outward from the peripheral frame 204 against the casing wall 106.

Another advantage imbued by the structural subframe 206 is that the peripheral frame 204 can be made using less substantial (e.g., thinner) structural elements 208 than would otherwise be needed to provide the desired strength and rigidity for the window system 200 if the peripheral frame 204 were the only portion of the window system 200 providing that strength and rigidity. This allows for more flexibility in designing the window system 200 so that it most closely matches the appearance of the permanent window 110. For example, the size and shape of each structural member 208 of the system frame 202 can be individually determined first of all by the desire to match the appearance of the permanent window 110, and then the quantity and placement (and perhaps choice of materials) of the structural members 208 can be determined such that the desired strength and rigidity of the system frame 202 are obtained.

FIG. 5 shows a fully constructed and assembled removable storm window system 200. Between the structural members 208 of the peripheral frame 204 and the attached subframe 206, in the window openings 210, are installed a plurality of sash windows (sashes) 220 that are individually removable and operable. The sashes 220 are a sash frame 222 holding a window pane 224 and a sash portion 226 of a sash attachment 230 mounted on the sash frame 222. A corresponding frame portion 228 of the sash attachment 230 is formed in the structural members of the system frame. The sash attachments 230, are, for example, a pivot pin 232 passing through a sliding mount into a hole in the frame, and a swinging latch 234 that swings into a slot in the frame. This allows the sash 220 to be removably installed, as well as operated by swinging open a latch 234 and pivoting the sash 220 on the pivot pin 232. No doubt many other forms of sash attachments 230 can be applied for this use, and all are considered within the scope of the present invention providing they are equivalent to the function of the sash attachments 230 in terms of allowing a sash window 220 to be removably installed in the system frame 202, and/or to be operable for opening and closing a portion of a window opening in the system frame 202.

FIG. 6 shows in partial cross section (where indicated by the line 6-6 in FIG. 5) a sash 220 that is permanently glazed with a window pane 224 (e.g., glass) and a resilient gasket 236 between an aluminum U-channel used for the sash frame 222 and the pane 224. A flange 262 (e.g., a rabbet) may be provided on the system frame 202 to make a stop against which the sash window 220 can be mounted and operably closed—optionally with a sash gasket 264 sealing the interface. A resilient, conformable frame gasket 260 is provided to seal the gap between the system frame 202 and the casing 106 as seen in FIG. 7. Note that the example installation illustrated in FIG. 7 shows a situation wherein the frame gasket 260 conforms to the rough brick surface plus the indented mortar, and also fills a V-shaped gap caused by a slanted casing wall 106. Many types of such gaskets 260 are known and may be used with the present invention as long as they meet requirements, if any, such as preventing drafts and/or conductive thermal transfer; such as providing a uniform appearance without unsightly gaps, and such as not marring the walls of the casing 106. For example, silicone caulk could be used as a sealing gasket 260 if unmarred removability isn't required. For example, the “gasket” 260 could be implemented as a decorative molding that covers the gap and is attached to the peripheral frame 204. Two preferred examples of suitable frame gaskets are resilient tubing 260a (hollow or solid) and a resilient leaf or ribbon 260b. The leaf gasket 260b could be advantageously used to seal the peripheral frame 204 if it is pressed back against the permanent window's frame 116.

The system frame 202 is held in the casing 106 by compressive system attachment devices 212 that press laterally outward from the peripheral frame 204 against the casing wall 106. A preferred embodiment of the system attachment device 212 is shown in partial cross section in FIG. 6. A screw threaded stud 240 travels in a correspondingly threaded screw hole 242. A convenient implementation of the screw hole 242 is shown as a threaded sleeve that is glued, riveted, or otherwise secured in the structural member 208 of the peripheral frame 204. The stud 240 has a rod portion 243 that extends laterally outward from the peripheral frame 204. This could be used by itself to apply pressure on the casing wall 106, but would no doubt mar the casing 106 when the stud 240 is screw-advanced laterally outward to press against it. To achieve a non-marring form of the compressive system attachment device 212, a protective pad 246 (e.g., a swivel pad) is provided at the end of the stud 240 to protect the casing wall 106. Preferably a cushioning pad 248 is on the end of the stud 240 (e.g., felt). More preferably the cushioning pad 248 is resilient such that it resists slipping as well as providing cushioning. If the cushioning pad 248 is made of a sufficiently resilient material it will add a spring bias to the compression of the screw stud 240, thereby allowing for expansion and contraction of the system frame 202 and/or the casing 106 when they are subjected to changes in thermal conditions (air temperature, radiant heating, etc.). A most preferred embodiment of the system attachment device 212 utilizes a bias spring 244 that has more range of compression/extension than a rubber pad. For example, FIG. 6 shows a coiled compression spring 244 contained in a sleeve 245 that holds it between and in line with the screw stud 240 and the pad(s) 246 and/or 248. The screw's rod portion 243 may advantageously be non-threaded for easier sliding in the spring sleeve 245. It will be seen in the forgoing description that there may be an advantage to leaving the compression springs 244 out of the bottom frame attachment devices 212 (if they are supporting too much weight), and possibly also the attachment devices 212 on one of the two side portions of the peripheral frame 204.

As best seen in FIG. 5, the system attachment devices 212 are spaced apart along all sides of the peripheral frame 204, some being recognized by the rectangular pad(s) 246, 248 and some by the circular threaded screw hole 242, as dictated by the angle of perspective view. The illustrated positioning of the system attachment devices 212 is merely representative. The actual quantity and positioning of the devices 212 will be decided by the designer of the system frame 202 according to engineering principles applied to existent factors such as characteristics of the casing walls 106, dimensions of the system frame 202, bending and compressive strength of the structural members 208, relative positioning of the subframe's structural members 208, and the like. These considerations provide evidence of benefit from the inventive use of a subframe structure 206 made of sturdy structural members 208 that extend between opposing portions of the peripheral frame 204. It should now be clear that the subframe members 208 are “load-bearing” like architectural mullions but not only for vertical weight loading from above, but rather in all directions due to the presence of compressive system attachment devices 212 which apply a reactive force laterally inward as they press laterally outward against any of the casing walls 106.

Installation of the inventive window system 200 is simplified by the use of the compressive system attachment devices 212, especially when they include a spring bias of some kind. Although the compressive force can be provided by a variety of attachment device 212 constructions, a preferred implementation is one that includes some type of screw adjustment (e.g., the screw threaded stud 240 in the threaded screw hole 242) for controlled lateral extension of a compressing element (e.g., stud 240, protective pad 246, and/or cushioning pad 248) toward and against the casing 106. Using the preferred screw adjustment (or a similar means of controlling the level of compressive force), the installation method for the removable storm window system 200 becomes a relatively simple matter of:

Holding a pre-constructed system frame 202 in position within the casing 106 while advancing the bottom system attachment devices 212 until the system frame 202 is positioned as desired both vertically and tilt-wise,

Advancing the system attachment devices 212 on one of the sides until the system frame 202 is positioned as desired horizontally, and

Advancing the top and other side system attachment devices 212 until a suitable and uniform amount of compressive force is developed for all of the frame attachment devices 212.

A screw 240 of a screw-adjustable compressive attachment device 212 can be turned by a power driver, and the “suitable” amount of compressive force can be determined initially by a knowledgeable person and then can be uniformly repeated, even by unskilled labor, using a torque limiter on the power driver. If a compressive biasing spring (e.g., spring 244) is used in the system attachment device 212, then there is a bit more latitude on the “suitable” amount of force (torque), and this makes installation even easier, along with the other advantages it brings (e.g., temperature change compensation).

This simple installation method allows the system frame 202 to be “squared up” in the casing 106, regardless of its shape.

It can be seen from the above described installation method that installation (or removal) is made much easier by not having the significant weight of window panes to deal with, not to mention the added risk of breakage taken on when installing a large window. Also, the removable storm window system 200 is much easier to transport when separated into packages of manageable weight.

FIGS. 4, 5, 7 and 8 illustrate some aspects of the versatility offered by the inventive removable storm window system 200.

The system frame 202 does not have to conform to the exact layout of the permanent window's muntins 108. Less structural members 208 can be employed, and then the rest of the framing lines can be provided by the sash window frames 222. In the illustrated example, the permanent window 110 has muntins 108 laid out in a five-row by ten-column pattern, whereas the window system 200 uses a system frame 202 laid out with only two vertical and two horizontal structural members 208 in the subframe 206 (see FIG. 4). Also, the subframe members 208 are spaced apart both vertically and horizontally to accommodate the height and width of the tilt window 114. Now using sash windows 220 of only two standardized sizes established by the bottom row of window openings 210, the five row appearance is maintained (see FIG. 5) because two of the sash windows 220 will fit in each of the two-row window openings 210, and the light blockage of the double row of adjacent top and bottom sash frame members 222 (shown close up in FIG. 7) looks similar to the light blockage of the rows divided by a structural member 208. Of course that effect can be improved upon by narrowing the width of the structural members 208, and/or by changing their height. For example, the horizontal members 208 could be reduced in height ⅜″ so that the sash windows 220 could be installed over them with top and bottom sash frames 222 abutting the same as they do in the double height window openings. This would not require any change to the sash attachments 230 as long as at least a portion of the vertical structural members 208 is left at the original height.

Where two sash frames 222 are abutted a sash gasket 264 can be affixed to one of the sash frame edges in order to seal the interface. Of course other means can be used, such as establishing an interference fit by shaping the abutting frame edges (e.g., edges that are slanted at slightly different angles).

FIG. 8 shows a portion of the removable storm window system 200 that is removably installed in front of the exemplary permanent window 110. A single one of the sash windows 220 (labeled sash 220a) has been unlatched (232) and pivoted open on its pivoting sash attachments 232 to allow access to the tilting portion 114 of the permanent window 110. This enabled opening the tilting window 114 into the space allowed by the opened sash 220a. The bottom one of the two sashes 220 in the window opening (labeled sash 220b) did not have to be opened, but could be in order to allow more ventilation. If the seasons have changed and the tilt window 114 will be opened frequently, then one or both of the center sash windows 220a, 220b can be easily removed for the sake of convenience. Removal is simply a matter of unlatching the latch 234 type of sash attachment 230 and sliding out the pivot pin 232 of the pivoting type of sash attachment 230.

Other advantages of the inventive window system 200 include the following.

Since they are not permanently glazed or otherwise installed into the system frame 202, the sash windows 220 can be made in a broad variety of forms and still be used in the same system frame 202. Thus sash windows 220, being glazing in a frame, can be for example single, double, or triple glazed, with a variety of glass types or any other type of “window pane” (including opaque panels and window screening). Differently glazed sashes 220 can be installed in different window openings 210, and can be moved around or changed as desired.

The window system 200 is prepared off-site and assembled very quickly on-site without the requirement of placing anchors into the walls. The installation does not require the occupants to leave the premises.

The subframe 206 is designed in such a way that it will transmit the compressive forces of the system attachment devices 212 without any buck playing off the peripheral frame 204.

The gaskets surrounding the system frame 202 and the individual sash windows 220 create an excellent seal against air leakage through any part of the wall opening covered by the inventive removable storm window system 200.

Although the invention has been illustrated and described in detail in the drawings and foregoing description, the same is to be considered as illustrative and not restrictive in character—it being understood that only preferred embodiments have been shown and described, and that all changes and modifications that come within the spirit of the invention as claimed are desired to be protected. Undoubtedly, many other “variations” on the “themes” set forth hereinabove will occur to one having ordinary skill in the art to which the present invention most nearly pertains, and such variations are intended to be within the scope of the invention, as disclosed herein.

What is claimed is:

1. A removable storm window system for insulating a permanent window that is fixed in a wall opening circumscribed by a casing with walls that project frontward from the permanent window; the window system comprising:
a system frame comprising structural members that form a peripheral frame and a subframe attached therein, the subframe comprising at least one structural member that extends between members of the peripheral frame, thereby creating a plurality of window openings in the system frame;
a system attachment device on the peripheral frame;
sashes dimensioned to sealingly fit in the window openings, each sash comprising a sash frame holding a window pane, and a sash portion of a sash attachment on the sash frame; and
a frame portion of the sash attachment on the system frame.
outline of potential other claims:
a. sashes are individually operable (sash attachment . . . )
b. sashes are individually removable (window attachment . . . )
c. system frame is dimensioned to fit within the casing of the permanent window, and the system attachment device adjustably projects laterally from the peripheral frame to the casing wall.
i. system attachment device comprises a screw-threaded stud in a correspondingly threaded screw hole
1. a compression spring biases stud toward the casing wall
2. protective pad at end of stud
3. resilient but stiff cushioning pad on end of stud (could be used as spring, as well as a no-mar feature)
d. a resilient gasket around peripheral frame for removably sealing the system frame within the window casing
e. the peripheral frame and the subframe structure are integrated to form a unitary, structurally robust system frame.
f. the window openings are flanged to provide a surface for sealing against the sash frames
g. a resilient gasket around the sash frame for removably sealing the sash frame in the window opening.
h. two or more sashes are operably attached within a single window opening.
a first sash is attached above a second sash; a bottom member of the first sash's frame and a top member of the second sash's frame are dimensioned to sealingly fit together when the first and second sashes are operably closed.
a resilient gasket around a sash frame seals adjacent portions of the first and second sash's frames against each other.

10. A method for insulating a permanent window that is in a casing that projects at least frontward from the permanent window, the method comprising:
offsite construction
matching subframe structure and sashes to the structure of the permanent window
install system frame first, then install sashes
torque wrench on spring biased pressure pads that can be adjustably extended from frame sides toward casing
